(19) United States
(12) Patent Application Publication
(10) Pub. No.: US 2015/0145884 A1
(43) Pub. Date: May 28, 2015

(54) MAKEUP COLOR SIMULATION APPARATUS AND METHOD

(71) Applicant: Electronics and Telecommunications Research Institute, Daejeon (KR)

(72) Inventors: Insu JANG, Daejeon (KR); Juyeon YOU, Daejeon (KR); Jinseo KIM, Daejeon (KR); Jihyung LEE, Daejeon (KR); Soonyoung KWON, Daejeon (KR); Songwoo LEE, Daejeon (KR); Jaewoo KIM, Daejeon (KR); Yoonseok CHOI, Daejeon (KR)

(73) Assignee: Electronics and Telecommunications Research Institute, Daejeon (KR)

(21) Appl. No.: 14/189,987

(22) Filed: Feb. 25, 2014

(30) Foreign Application Priority Data
Nov. 27, 2013 (KR) 10-2013-0145333

(51) Int. Cl. G01J 3/46; G06T 7/40; G09G 5/02

(52) U.S. Cl. CPC G01J 3/463; G09G 5/02; G06T 7/408; G01J 2003/467; G09G 2340/06; G06T 2207/10024; G06T 2207/30196
USPC 345/603

(57) ABSTRACT

Disclosed are an apparatus and method that measure and analyze the colors of skin based on a spectrum before and after the application of makeup, and then estimate spectral variations in skin before and after the application of makeup and simulate color of any skin after the application of makeup. The makeup color simulation apparatus acquires a spectral image from a captured skin image. Spectral variations in skin before and after application of makeup are estimated. A spectral variation model is created based on the estimated spectral variations, and spectral data of skin varied after application of makeup is calculated based on the spectral variation model. The spectral data of the skin is converted into CIE XYZ color values. The CIE XYZ color values are converted depending on input/output characteristics of an image display unit, and a final image corresponding to results of the conversion is simulated.

### CROSS REFERENCE TO RELATED APPLICATION

This application claims the benefit of Korean Patent Application No. 10-2013-0145333 filed on Nov. 27, 2013, which is hereby incorporated by reference in its entirety into this application.

### BACKGROUND OF THE INVENTION

1. Technical Field

The present invention relates generally to a makeup color simulation apparatus and method and, more particularly, to an apparatus and method that measure and analyze the colors of skin based on a spectrum before and after the application of makeup, and then estimate variations in the spectrum of the skin before and after the application of makeup and simulate the color of any skin after the application of makeup by using the results of the estimation.

2. Description of the Related Art

Color is perceived by a human being via the complex actions of lighting, an object, and a human visual system. Therefore, in order to exactly reproduce color on a display, procedures, for example, a procedure for exactly measuring, analyzing, and modeling lighting and an object in an input unit and a procedure for characterizing display color in an output unit, are required.

However, in a conventional method of reproducing makeup color, color after the application of makeup is simply estimated using the spectral reflectance of skin, the spectral reflectance of cosmetics, and the spectral distribution of a light source.

For example, U.S. Patent Application Publication No. 2012-0123759 entitled “System and method for recommending sensitive makeup based on skin tone of a user.” This patent discloses a system which includes an avatar creator for creating an avatar image using skin information obtained by scanning a user's body, a cosmetics information processor for generating analysis information by analyzing a plurality of cosmetics and then storing the generated information in a database, and a simulator for displaying results of performing a make-up simulation on the avatar image based on the analysis information on certain cosmetics selected by the user and the skin information.

Such a scheme for simulating color (tone) can estimate a color appearing when a specific amount of cosmetics is applied to any skin, but it is impossible to reproduce colors for the effects of re-applying cosmetics several times during the application of actual makeup. That is, it is difficult to estimate variations in the degree of reaction to skin and the thickness of the applied cosmetics depending on the physical and chemical characteristics of the cosmetics by using only the spectral reflectance of the cosmetics.

Therefore, in order to accurately estimate such variations, it is required to measure spectral variations in skin before and after the application of makeup to various skin types, and estimate color changes via the modeling of spectral variations for respective types of cosmetics based on the results of measurement. If such estimated spectral information is generally converted into a simple RGB standard color space, the color reproduction characteristics of a display to reproduce colors are not taken into consideration, thus causing color errors. Therefore, in order to display such estimated results on a monitor or a television (TV), a procedure for converting spectral data into RGB colors via a color characterization procedure for the display is required.

### SUMMARY OF THE INVENTION

Accordingly, the present invention has been made keeping in mind the above problems occurring in the prior art, and an object of the present invention is to provide an apparatus and method that measure and analyze the colors of skin based on a spectrum before and after the application of makeup, and then estimate variations in the spectrum of the skin before and after the application of makeup and simulate the color of any skin after the application of makeup by using the results of the estimation.

In accordance with an aspect of the present invention to accomplish the above object, there is provided a makeup color simulation method including acquiring a spectral image from a captured skin image using a makeup color simulation apparatus; estimating spectral variations in the skin before and after application of makeup to the skin; creating a spectral variation model based on the estimated spectral variations, and calculating spectral data of the skin varied after the application of makeup, based on the created spectral variation model; converting the spectral data of the skin into International Commission on Illumination (CIE) XYZ color values; and converting the CIE XYZ color values depending on input/output characteristics of an image display unit, and simulating a final image corresponding to results of the conversion on the image display unit.

Preferably, acquiring the spectral image may be configured to acquire the spectral image by performing a spectrum-based camera characterization procedure on the captured skin image.

Preferably, calculating the spectral data of the skin varied after the application of makeup may be configured such that the spectral data of the skin varied after the application of makeup corresponds to spectral data of reflected light after the application of makeup.

Preferably, calculating the spectral data of the skin varied after the application of makeup may be configured to calculate the spectral data of the reflected light by multiplying a spectral reflectance of the skin by a spectral distribution of a standard light source.

Preferably, converting into the CIE XYZ color values may be configured to individually multiply the spectral data of the skin by three color matching functions, integrate results of multiplication, convert results of integration into CIE XYZ color values of X, Y, and Z, respectively, and generate CIE XYZ data in a standard color space.

Preferably, at simulating, converting the CIE XYZ color values depending on the input/output characteristics of the image display unit may include performing a color characterization procedure for modeling output luminance and color characteristics depending on digital input values of the image display unit.

In accordance with another aspect of the present invention to accomplish the above object, there is provided a makeup color simulation apparatus including an image acquisition unit for acquiring a spectral image from a captured skin image; a spectral variation estimation unit for estimating spectral variations in the skin before and after application of makeup to the skin; a spectral variation application unit for creating a spectral variation model based on the estimated spectral variations, and calculating spectral data of the skin varied after the application of makeup, based on the created spectral variation model; and a color conversion unit for converting the spectral data of the skin into CIE XYZ color values, converting the CIE XYZ color values depending on input/output characteristics of an image display unit, and simulating a final image corresponding to results of the conversion on the image display unit.

Preferably, the image acquisition unit may be configured to acquire the spectral image by performing a spectrum-based camera characterization procedure on the captured skin image.

Preferably, the spectral variation application unit may be configured such that the spectral data of the skin varied after the application of makeup corresponds to spectral data of reflected light after the application of makeup.

Preferably, the spectral variation application unit may calculate the spectral data of the reflected light by multiplying a spectral reflectance of the skin by a spectral distribution of a standard light source.

Preferably, the color conversion unit may individually multiply the spectral data of the skin by three color matching functions, integrate results of multiplication, convert results of integration into CIE XYZ color values of X, Y, and Z, respectively, and generate CIE XYZ data in a standard color space.

Preferably, the color conversion unit may be configured such that conversion of the CIE XYZ color values depending on the input/output characteristics of the image display unit includes a color characterization procedure for modeling output luminance and color characteristics depending on digital input values of the image display unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing a makeup color simulation apparatus according to an embodiment of the present invention;

FIG. 2 is a diagram showing the spectral data of skin measured in a makeup application procedure according to an embodiment of the present invention;

FIG. 3 is a diagram showing a procedure for converting spectral data into CIE XYZ data according to an embodiment of the present invention; and

FIG. 4 is a flowchart showing a makeup color simulation method according to an embodiment of the present invention.

FIG. 5 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Hereinafter, a makeup color simulation apparatus and method according to embodiments of the present invention will be described in detail with reference to the attached drawings.

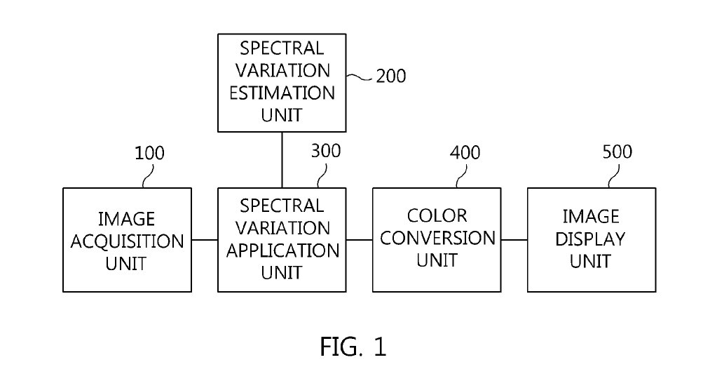

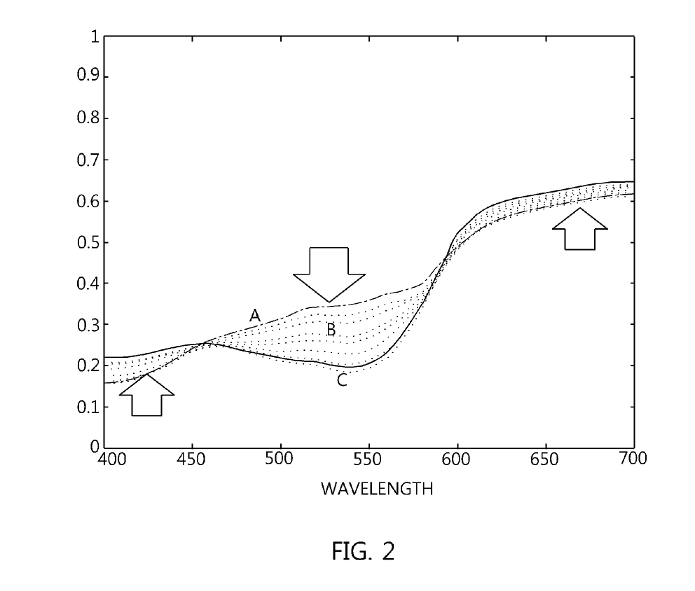

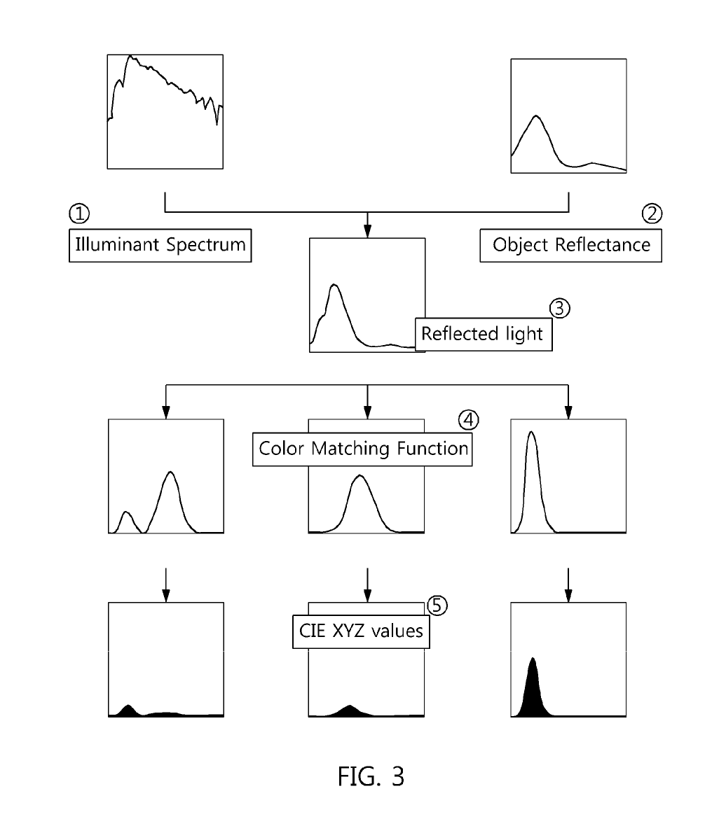

FIG. 1 is a diagram schematically showing a makeup color simulation apparatus according to an embodiment of the present invention, FIG. 2 is a diagram showing the spectral data of skin measured in a makeup application procedure according to an embodiment of the present invention, and FIG. 3 is a diagram showing a procedure for converting spectral data into CIE XYZ data according to an embodiment of the present invention.

Referring to FIG. 1, a makeup color simulation apparatus includes an image acquisition unit 100, a spectral variation estimation unit 200, a spectral variation application unit 300, a color conversion unit 400, and an image display unit 500.

The image acquisition unit 100 acquires spectral data (a spectral image) obtained by capturing skin, that is, a captured skin image, using a specific imaging device.

In detail, the captured skin image is a typical RGB image. In order to estimate the spectral information of the skin using the captured skin image, a spectrum-based camera characterization procedure must be foregone.

The spectrum-based camera characterization procedure corresponds to a procedure for estimating the input/output signal characteristics of a camera which is the imaging device. Such a procedure is configured to estimate correlations between RGB data acquired by capturing a color simple patch using the camera and spectral data obtained by measuring the RGB data using a measurement device.

The spectrum-based camera characterization procedure according to an embodiment of the present invention estimates a function F for minimizing errors in a spectrum estimated using various types of sample data, and uses the estimated function F as a spectrum-based camera characterization model. In this case, the function F is represented by the following Equation (1).

Generally, in order to obtain the function, a polynomial regression equation may be used. In the present invention, depending on the characteristics of samples to be used, errors in the results of estimation appear as different values, and thus color samples including colors related to skin and cosmetics must be used to minimize errors.

s=F(dₖ)

Referring to Equation (1), d denotes an RGB value corresponding to an input digital value, k denotes an RGB channel, and s denotes spectral data (image).

That is, the image acquisition unit 100 converts the captured skin image, that is, the RGB image of skin, into a spectral image using the spectrum-based camera characterization model.

The spectral variation estimation unit 200 estimates spectral variations before and after the application of makeup.

In detail, the spectral variation estimation unit 200 estimates spectral variations before and after the application of makeup by using makeup information such as information about various skin samples, cosmetics, and makeup sets.

The spectral variation estimation unit 200 repeats, for example, a procedure for measuring spectral variations after applying each of specific cosmetic products to various skin samples using makeup sets, and re-measuring spectral variations after re-applying the specific cosmetic product to the skin samples, thus measuring changes in skin color during a makeup application procedure for actually re-applying the cosmetic product.

Referring to FIG. 2, alternative long and short dash line A indicates skin spectral data corresponding to skin before the application of makeup, and solid line C indicates skin spectral data after the application of final makeup, which corresponds to skin after the final makeup has been applied. Dotted lines B indicate pieces of spectral data in a makeup application procedure, which are measured after a predetermined amount of cosmetics has been re-applied at each time using makeup sets.

In the case of the final makeup application, variations in spectral data are not present any longer as in the case of sold line C, and are similar to those of unique spectral data obtained when only cosmetics are measured. Therefore, the makeup application procedure corresponds to a procedure for making a transition from skin spectral data to cosmetics spectral data, as shown in FIG. 2.

When a spectrum range of 400 nm to 700 nm corresponding to a visible light region is considered, it can be seen that a large variation occurs in a direction in which values are decreasing in a region of 460 nm to 580 nm, whereas values are increasing in the remaining two regions, but a variation in the values is small. This is caused by the characteristics of reaction of the skin to the cosmetics, and the trend of the variations differs according to the type of cosmetics.

The spectral variation application unit 300 creates a spectral variation model based on the spectral variations estimated by the spectral variation estimation unit 200, and calculates the spectral data of reflected light based on the created spectral variation model. In this case, the spectral data denotes spectral data corresponding to the skin varied after the application of makeup.

In detail, the spectral variation application unit 300 estimates spectral variations appearing in the makeup application procedure using a statistical modeling method, as shown in FIG. 2. The spectral variation application unit 300 creates a spectral variation model based on the results of estimation performed by the spectral variation estimation unit 200, that is, the results of measuring the trend of variations on the various skin samples via the same experiment. Here, since variation trends for respective wavelengths are different from each other, a number of spectral variation models identical to the number of sample wavelengths are required. That is, for the variation trends for respective wavelengths, linear or non-linear spectral variation models are used.

For example, in a region of 400 nm to 690 nm, variation trends for pieces of spectral data corresponding to intervals of 10 nm may be modeled and represented in graphs (not shown). In this case, as the application of makeup has been completed at a wavelength of 400 nm (proportional to the number of makeup applications), variations in spectral data may represent normalized data, and the results of estimating variation trends may be represented by a second- or higher-order polynomial given by the following Equation (2):

r=G_{λ}(c) (2)

Referring to Equation (2), r denotes variations in wavelength 2 depending on input c. Further, G, may be applied to a higher-order polynomial, as given by the following Equation (3):

G_{λ}=aₙcⁿ+aₙ₋₁c^{c-1}+ . . . +a₁c¹+a₀ (3)

Referring to Equation (3), spectral variations for respective wavelengths depending on any input c, for example, the number of re-applications in the makeup application procedure or the amount of cosmetics used, may be calculated using the coefficient values of the polynomial, and may be used as the spectral variation models of cosmetics.

In order to estimate the spectral data of reflected light, that is, spectral data varied after the application of makeup, based on the spectral variation models, the spectral variation application unit 300 requires polynomials for a skin spectrum before the makeup application procedure, the spectral data of cosmetics, and differences between variations for respective wavelengths.

Spectral variations in skin denote a procedure for making a transition from base skin to the spectral data of cosmetics, as shown in FIG. 2, and thus the ratio r of variations to a specific procedure c is obtained. Thereafter, a part corresponding to an interval between the spectral data of the skin and the spectral data of cosmetics may be increased or decreased, as given by the following Equation (4):

s₀=s_{b}+(s_{c}−s_{b})*r (4)

Referring to Equation (4), s_{b} denotes the spectral data of skin which is the base, and s_{c} denotes the spectral data of cosmetics.

In order to reproduce the skin spectral data varied after makeup has been applied, information about a light source is required.

As described above, since color information is obtained by perceiving light, which has been emitted from a light source and has been reflected from an object, with human eyes, it is impossible to reproduce colors using only spectral data corresponding to the spectral reflectance of the skin.

As the light source, different types of light sources may be used depending on the user's request, but a standard D65 light source is basically and widely used.

Next, in FIG. 3, a procedure for converting spectral data into data in an International Commission on Illumination (CIE) XYZ standard color space is illustrated.

The spectral variation application unit 300 calculates the spectral data of reflected light (\textcircled{3} in FIG. 3) by multiplying the spectral reflectance of an object (\textcircled{2} in FIG. 3), that is, the spectral data of the skin, by the spectral distribution (illuminant spectrum) of the standard D65 light source (\textcircled{1} in FIG. 3).

The color conversion unit 400 individually multiplies the spectral data calculated by the spectral variation application unit 300 by three color matching functions (\textcircled{4} in FIG. 3), integrates the results of the multiplication, converts the results of the integration into CIE XYZ color values of X, Y, and Z, respectively, and generates CIE XYZ data in the standard color space. Here, the standard color space to which the CIE XYZ color values are applied corresponds to a standard color space defined by the International Commission on Illumination (CIE).

The color conversion unit 400 must estimate the input/output characteristics of the image display unit 500 so as to simulate the CIE XYZ data on the image display unit 500.

For this, the color conversion unit 400 performs a color characterization procedure for modeling the output luminance and color characteristics depending on the digital input values of the image display unit 500. That is, the colors of the image display unit 500, output depending on various digital input values, are measured by a colorimeter (not shown), and the input/output characteristics of the image display unit 500 are modeled using the measured colors.

Generally, in the case of a display such as the image display unit 500, since output colors are changed depending on RGB input signals, the input/output characteristics of respective RGB channels are modeled into one-dimensional functions, and final colors are estimated by means of linear combination of the one-dimensional functions. Generally, as a one-dimensional function, a gain-offset-gamma (GOG) model or an S-curve model is widely used.

The CIE XYZ color values converted by the color conversion unit 400 are converted into linear RGB values using a third-order transfer matrix, as given by the following Equation (5). The third-order transfer matrix used at this time is an inverse matrix of XYZ values measured by indicating R(255,0,0), G(0,255,0), B(0,0,255) corresponding to the input values of the image display unit 500.

$$[ \begin{matrix}{R}_{sRGB} \\ {G}_{sRGB} \\ {B}_{sRGB}\end{matrix} ] = [ \begin{matrix}3.2406 & - 1.5372 & - 0.4986 \\ - 0.9689 & 1.8758 & 0.0415 \\ 0.0557 & - 0.2040 & 1.0570\end{matrix} ] [ \begin{matrix}X \\ Y \\ Z\end{matrix} ] \qquad ( 5 )$$

As described above, the color conversion unit 400 converts the acquired linear RGB data into RGB data using a GoG model or an S-curve model so as to incorporate the color characteristics of the image display unit 500 into the linear RGB data, and displays the resulting RGB data (=RGB image) on the image display unit 500.

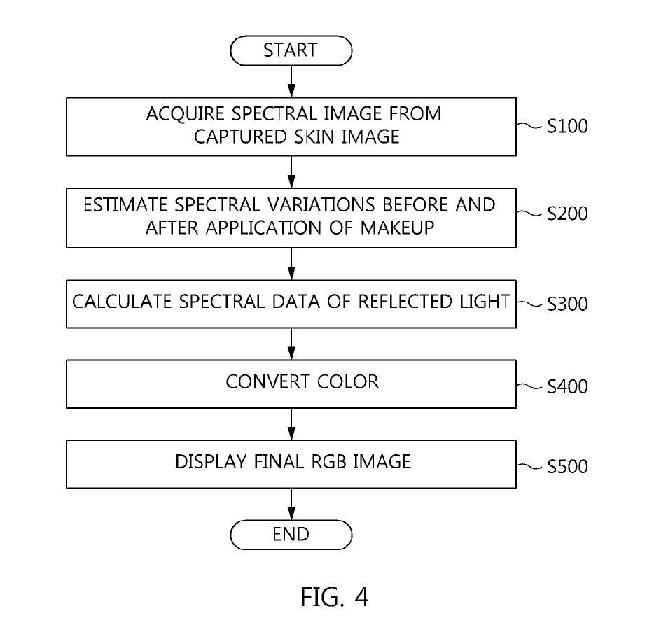

Below, a makeup color simulation method will be described in detail with reference to FIG. 4.

FIG. 4 is a flowchart showing a makeup color simulation method according to an embodiment of the present invention.

Referring to FIG. 4, the makeup color simulation apparatus acquires a spectral image (spectral data) from an image obtained by capturing skin using a specific imaging device, that is, a captured skin image, at step S100. Here, the captured skin image is a typical RGB image. In order to estimate the spectral information of the skin using the captured skin image, a spectrum-based camera characterization procedure must be foregone.

In the spectrum-based camera characterization procedure according to an embodiment of the present invention, a function F for minimizing errors in a spectrum estimated using various types of sample data is estimated, and the estimated function F is used as a spectrum-based camera characterization model. Here, the function F is represented by the above Equation (1).

That is, the makeup color simulation apparatus converts the captured skin image, that is, the RGB image of the skin, into a spectral image using the spectrum-based camera characterization model.

Then, the makeup color simulation apparatus estimates spectral variations before and after the application of makeup at step S200.

In detail, the makeup color simulation apparatus estimates spectral variations before and after the application of makeup by using makeup information such as information about various skin samples, cosmetics, and makeup sets. For example, the makeup color simulation apparatus repeats a procedure for measuring spectral variations after applying each of specific cosmetic products to various skin samples using makeup sets, and re-measuring spectral variations after re-applying the specific cosmetic product to the skin samples, thus measuring changes in skin color during a makeup application procedure for actually re-applying the cosmetic product.

The makeup color simulation apparatus creates a spectral variation model based on the spectral variations estimated at step S200, and calculates the spectral data of reflected light based on the created spectral variation model at step S300. In this case, spectral data denotes spectral data corresponding to the skin varied after makeup has been applied.

In detail, the makeup color simulation apparatus creates the spectral variation model, based on the results of estimating spectral variations appearing in the makeup application procedure using a statistical modeling method, as shown in FIG. 2, that is, the results of measuring the trend of variations on the various skin samples via the same experiment. Here, since variation trends for respective wavelengths are different from each other, a number of spectral variation models identical to the number of sample wavelengths are required. That is, for the variation trends for respective wavelengths, linear or non-linear spectral variation models are used.

The makeup color simulation apparatus calculates the spectral data of reflected light (\textcircled{3} in FIG. 3) by multiplying the spectral reflectance of an object (\textcircled{2} in FIG. 3), that is, the spectral data of the skin, by the spectral distribution (illuminant spectrum) of the standard D65 light source (\textcircled{1} in FIG. 3), based on the created spectral variation models.

The makeup color simulation apparatus individually multiplies the spectral data calculated at step S300 by three color matching functions (\textcircled{4} in FIG. 3), integrates the results of the multiplication, converts the results of the integration into CIE XYZ color values of X, Y, and Z, respectively, and generates CIE XYZ data in a standard color space at step S400. Here, the standard color space to which the CIE XYZ color values are applied corresponds to a standard color space defined by the International Commission on Illumination (CIE).

Further, the makeup color simulation apparatus must estimate the input/output characteristics of the image display unit 500 so as to simulate the CIE XYZ data on the image display unit 500. For this, the makeup color simulation apparatus performs a color characterization procedure for modeling the output luminance and color characteristics depending on the digital input values of the image display unit 500. That is, the colors of the image display unit 500, output depending on various digital input values, are measured by a colorimeter (not shown), and the input/output characteristics of the image display unit 500 are modeled using the measured colors.

The makeup color simulation apparatus converts the CIE XYZ color values converted at step S400 into linear RGB values using a third-order transfer matrix, as given by the above Equation (5).

The makeup color simulation apparatus finally converts the linear RGB values into RGB data (=RGB image) by incorporating the color characteristics of the display unit 500 into the linear RGB values, and displays the final RGB image on the display unit 500 at step S500.

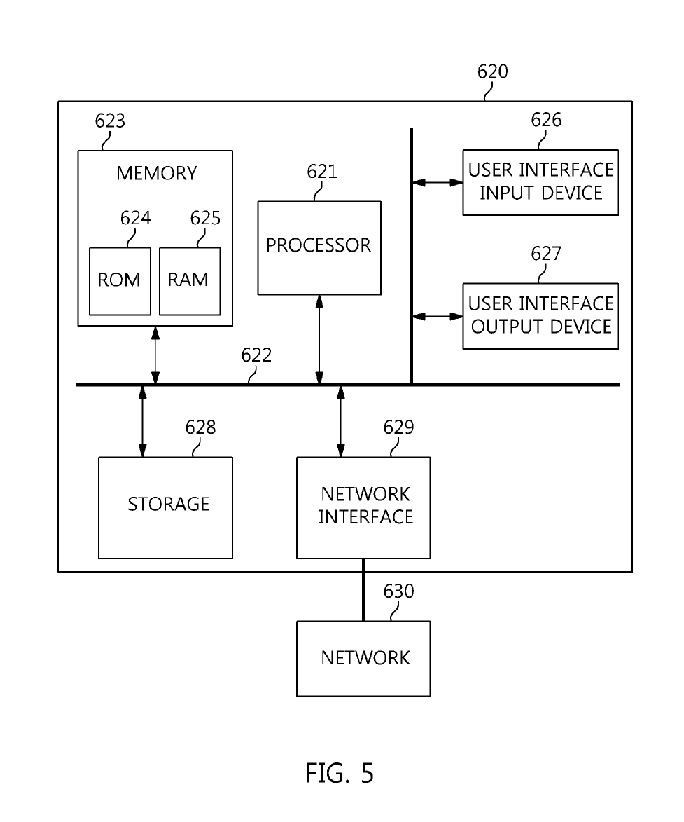

FIG. 5 is an embodiment of the present invention implemented in a computer system.

Refering to FIG. 5, an embodiment of the present invention may be implemented in a computer system, e.g., as a computer readable medium. As shown in in FIG. 5, a computer system 620 may include one or more of a processor 621, a memory 623, a user input device 626, a user output device 627, and a storage 628, each of which communicates through a bus 622. The computer system 620 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory(RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention, the makeup color simulation apparatus and method are configured to measure the spectral variations of skin in a makeup application procedure, and perform spectrum-based makeup color reproduction modeling for each of cosmetics using the skin spectral variations, thus estimating exact changes in skin color. Further, in order to exactly reproduce makeup color, spectral data is acquired from a captured skin image via spectrum-based camera characterization. Spectral variations in skin depending on specific cosmetics in a makeup application procedure are estimated using a spectrum-based makeup color reproduction model. The estimated spectral data (image) is converted into reproducible RGB signals (image) via display characterization under a specific light source, and the RGB signals are displayed. This enables the spectral variations of skin in a makeup application procedure, which could not be estimated using only the simple spectral data of skin and cosmetics in the prior art, to be estimated via the statistical modeling of spectral variations in the makeup application procedure, thus enabling the simulation of the makeup application procedure to be more realistically reproduced by means of such estimation.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A makeup color simulation method, comprising:
acquiring a spectral image from a captured skin image using a makeup color simulation apparatus;
estimating spectral variations in the skin before and after application of makeup to the skin;
creating a spectral variation model based on the estimated spectral variations, and calculating spectral data of the skin varied after the application of makeup, based on the created spectral variation model;
converting the spectral data of the skin into International Commission on Illumination (CIE) XYZ color values; and
converting the CIE XYZ color values depending on input/output characteristics of an image display unit, and simulating a final image corresponding to results of the conversion on the image display unit.

2. The makeup color simulation method of claim 1, wherein acquiring the spectral image is configured to acquire the spectral image by performing a spectrum-based camera characterization procedure on the captured skin image.

3. The makeup color simulation method of claim 1, wherein calculating the spectral data of the skin varied after the application of makeup is configured such that the spectral data of the skin varied after the application of makeup corresponds to spectral data of reflected light after the application of makeup.

4. The makeup color simulation method of claim 3, wherein calculating the spectral data of the skin varied after the application of makeup is configured to calculate the spectral data of the reflected light by multiplying a spectral reflectance of the skin by a spectral distribution of a standard light source.

5. The makeup color simulation method of claim 1, wherein converting into the CIE XYZ color values is configured to individually multiply the spectral data of the skin by three color matching functions, integrate results of multiplication, convert results of integration into CIE XYZ color values of X, Y, and Z, respectively, and generate CIE XYZ data in a standard color space.

6. The makeup color simulation method of claim 1, wherein, at simulating, converting the CIE XYZ color values depending on the input/output characteristics of the image display unit comprises performing a color characterization procedure for modeling output luminance and color characteristics depending on digital input values of the image display unit.

7. A makeup color simulation apparatus, comprising:
an image acquisition unit for acquiring a spectral image from a captured skin image;
a spectral variation estimation unit for estimating spectral variations in the skin before and after application of makeup to the skin;
a spectral variation application unit for creating a spectral variation model based on the estimated spectral variations, and calculating spectral data of the skin varied after the application of makeup, based on the created spectral variation model; and
a color conversion unit for converting the spectral data of the skin into CIE XYZ color values, converting the CIE XYZ color values depending on input/output characteristics of an image display unit, and simulating a final image corresponding to results of the conversion on the image display unit.

8. The makeup color simulation apparatus of claim 7, wherein the image acquisition unit is configured to acquire the spectral image by performing a spectrum-based camera characterization procedure on the captured skin image.

9. The makeup color simulation apparatus of claim 7, wherein the spectral variation application unit is configured such that the spectral data of the skin varied after the application of makeup corresponds to spectral data of reflected light after the application of makeup.

10. The makeup color simulation apparatus of claim 9, wherein the spectral variation application unit calculates the spectral data of the reflected light by multiplying a spectral reflectance of the skin by a spectral distribution of a standard light source.

11. The makeup color simulation apparatus of claim 7, wherein the color conversion unit individually multiplies the spectral data of the skin by three color matching functions, integrates results of multiplication, converts results of integration into CIE XYZ color values of X, Y, and Z, respectively, and generates CIE XYZ data in a standard color space.

12. The makeup color simulation apparatus of claim 7, wherein the color conversion unit is configured such that conversion of the CIE XYZ color values depending on the input/output characteristics of the image display unit comprises a color characterization procedure for modeling output luminance and color characteristics depending on digital input values of the image display unit.
